(19) United States
(12) Patent Application Publication
(10) Pub. No.: US 2021/0010444 A1
(43) Pub. Date: Jan. 14, 2021

(54) ENGINE

(71) Applicant: HONDA MOTOR CO., LTD., Tokyo (JP)

(72) Inventors: Soji KASHIMA, Saitama (JP); Toshiro KIURA, Saitama (JP); Kota TOKUBI, Saitama (JP)

(73) Assignee: HONDA MOTOR CO., LTD., Tokyo (JP)

(21) Appl. No.: 17/038,821

(22) Filed: Sep. 30, 2020

Related U.S. Application Data
(63) Continuation-in-part of application No. PCT/JP2018/013837, filed on Mar. 30, 2018.
Application No. PCT/JP2018/013837 is a continuation-in-part of application No. PCT/JP2018/013854, filed on Mar. 30, 2018.

(51) Int. Cl. F02F 7/00; F02F 1/24; F01L 1/047; F01L 1/18; F01L 1/14; F01L 1/46; F01M 13/00

(52) U.S. Cl. CPC F02F 7/0043; F02F 1/24; F01L 1/047; F01M 13/00; F01L 1/146; F01L 1/462; F01L 1/18

(57) ABSTRACT

An engine is provided with: a crank case that has a first crank shaft insertion hole and a second crank shaft insertion hole along the vertical direction; a crank shaft that is inserted into the first and second shaft insertion holes; and a cylinder unit that extends in the front-rear direction from the crank case. The cylinder unit is provided with a cylinder base that is positioned inside the crank case, and a cylinder block that is positioned outside the crank case. The cylinder unit is detachably attached to the crank case.

### CROSS REFERENCE TO RELATED APPLICATIONS

This application is a continuation in part of International Patent Application No. PCT/JP2018/013837 filed on Mar. 30, 2018 and International Patent Application No. PCT/JP2018/013854 filed on Mar. 30, 2018, contents of which are incorporated herein by reference.

### TECHNICAL FIELD

The present invention relates to an engine which can be mounted on a working machine such as a lawn mower or a high pressure washer.

### BACKGROUND ART

Generally, an engine includes a crankcase including first and second bearing portions which support both ends of a crankshaft and a cylinder into which a piston is fitted. For example, JP2017-160833A discloses an engine in which a crankcase is formed of first and second case half bodies which are joined to each other at a dividing surface which diagonally intersects axes of first and second bearing portions and a cylinder and the first bearing portion are integrally formed on the first case half body, and further the second bearing portion is integrally formed on the second case half body.

### SUMMARY OF INVENTION

However, in the engine structure of JP2017-160833A, when providing a plurality of types of engines with different displacements, it is necessary to prepare a plurality of types of engine bodies (at least engine blocks) according to the displacements, which may significantly increase the manufacturing cost.

One aspect of the invention is to provide an engine capable of inexpensively manufacturing an engine body having different displacements.

According to an aspect of the invention, an engine includes: a crankcase portion including a first crankshaft insertion hole and a second crankshaft insertion hole along a first direction; a crankshaft inserted through the first crankshaft insertion hole and the second crankshaft insertion hole; and a cylinder unit extending from the crankcase portion in a second direction orthogonal to the first direction. The cylinder unit includes, a cylinder base portion located inside the crankcase portion, and a cylinder block located outside the crankcase portion, and the cylinder unit is detachably attached to the crankcase portion.

### BRIEF DESCRIPTION OF DRAWINGS

FIG. 1 is a cross-sectional view of an engine according to an embodiment of the invention.

FIG. 2 is a perspective view of the engine with a top cover removed as viewed from diagonally above and front.

FIG. 3 is an exploded perspective view of the engine as viewed from obliquely above and front.

FIG. 4 is an exploded perspective view of an engine body as viewed from diagonally above and front.

FIG. 5 is a plan view of the engine with a crankcase cover removed.

FIG. 6 is a cross-sectional view taken along the line A-A of FIG. 5.

FIG. 7 is a perspective view of a valve mechanism of the engine as viewed from obliquely above and front.

FIG. 8 is an exploded perspective view of the valve mechanism of the engine as viewed from obliquely above and front.

### DESCRIPTION OF EMBODIMENTS

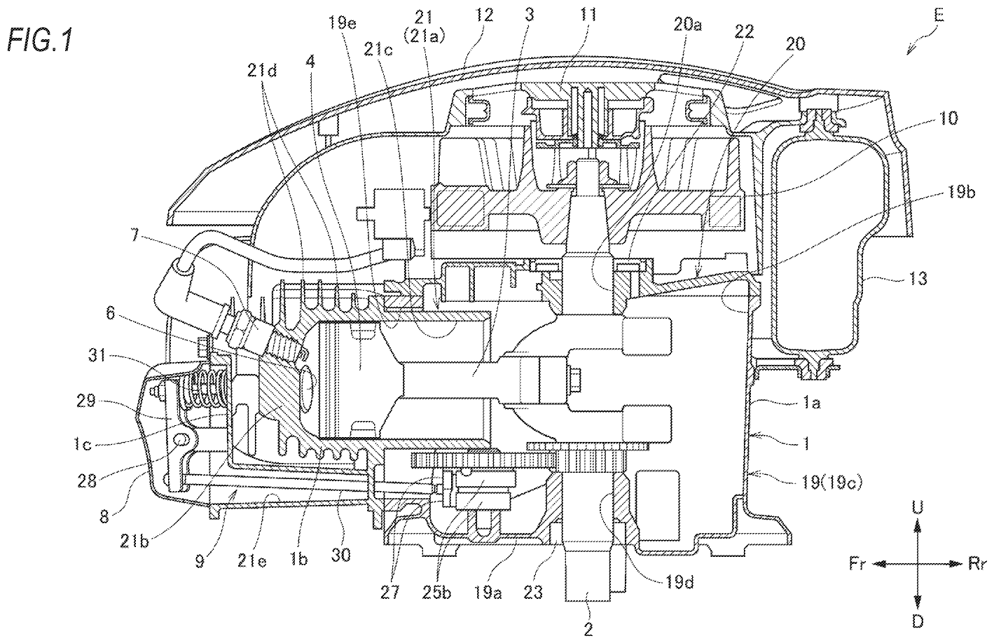

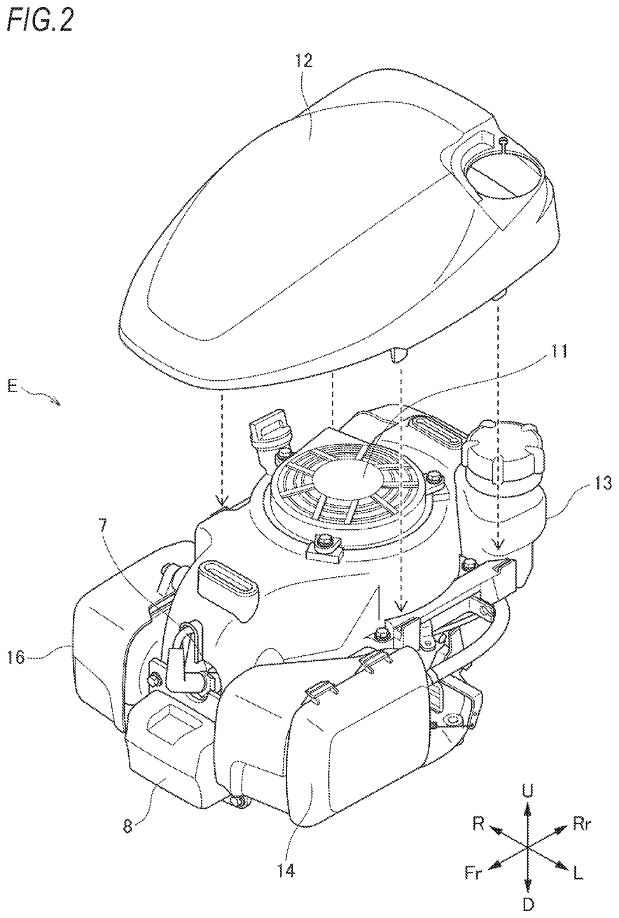

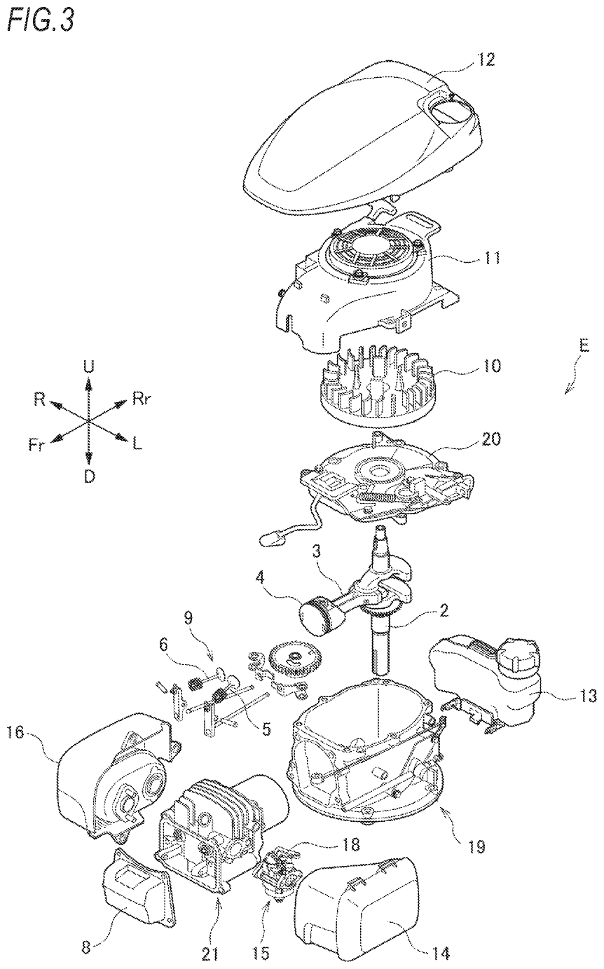

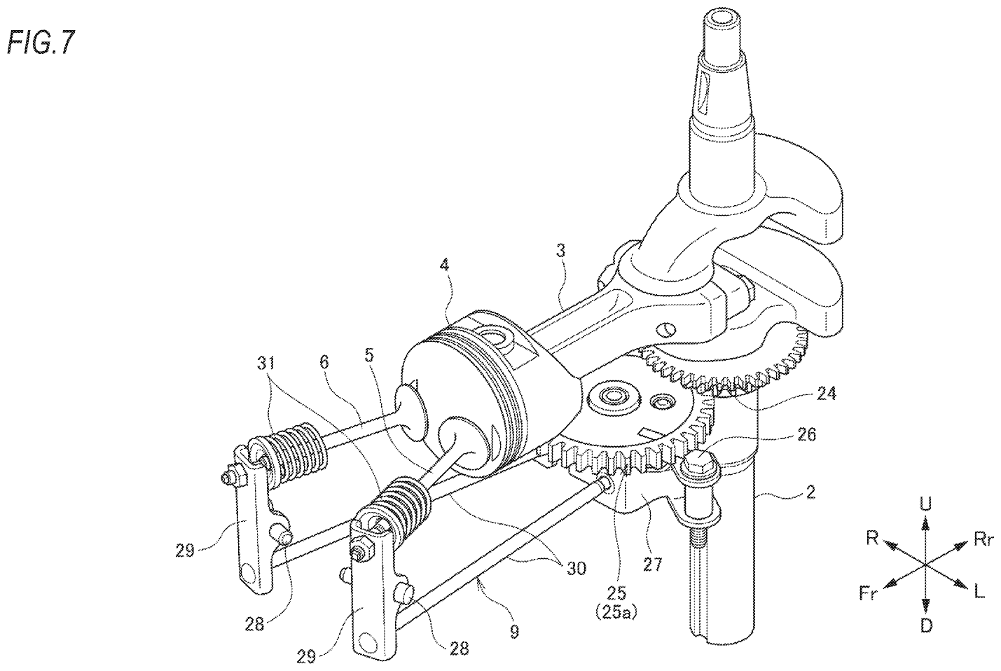

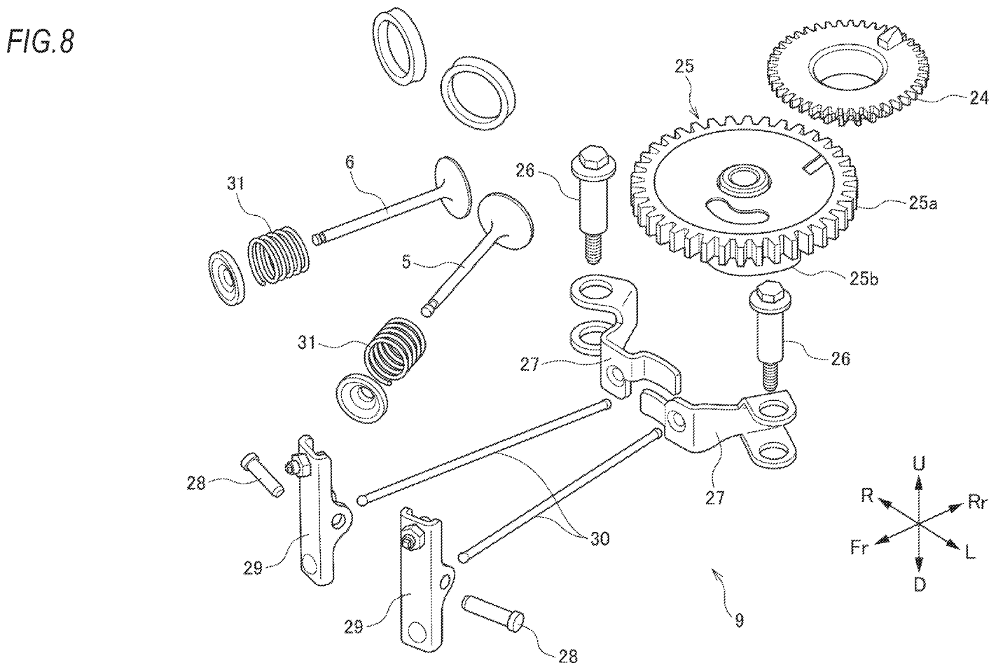

Hereinafter, an embodiment of the invention will be described with reference to FIGS. 1 to 8. An engine E of the embodiment is a small general-purpose engine mounted on a walk-type lawnmower or the like and constitutes an OHV engine. In the present specification and the like, in order to simplify and clarify the explanation, an axial direction of a crankshaft 2 is defined as an up-down direction (first direction), a direction which is perpendicular to the up-down direction and in which a cylinder portion 1b extends is defined as a front-back direction (second direction), and a direction perpendicular to the up-down direction and the front-back direction is defined as a left-right direction. In the drawing, the front of the engine E is shown as Fr, the rear as Rr, the left as L, the right as R, the upper as U, and the lower as D.

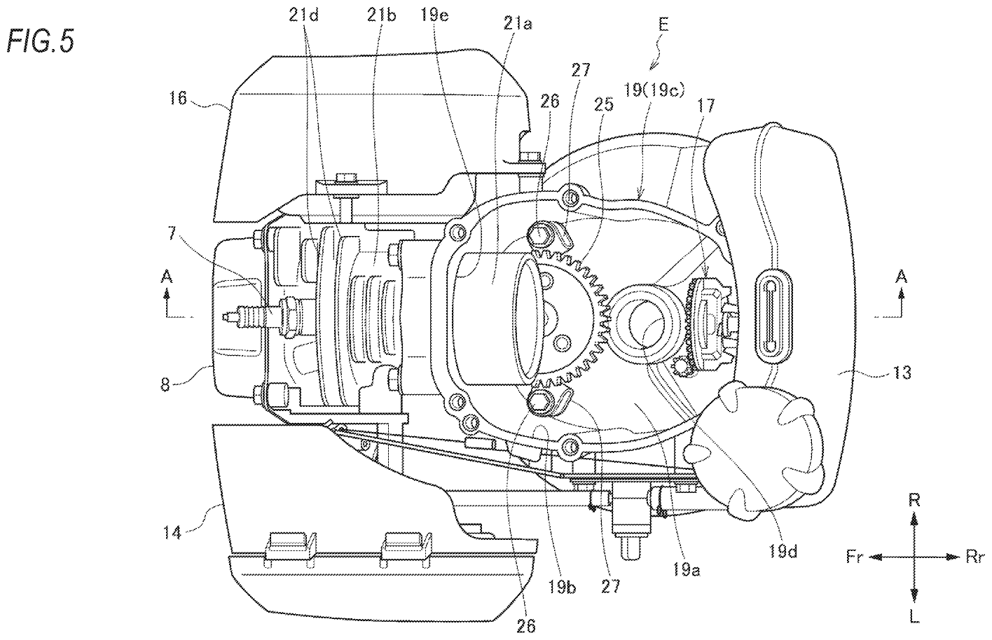

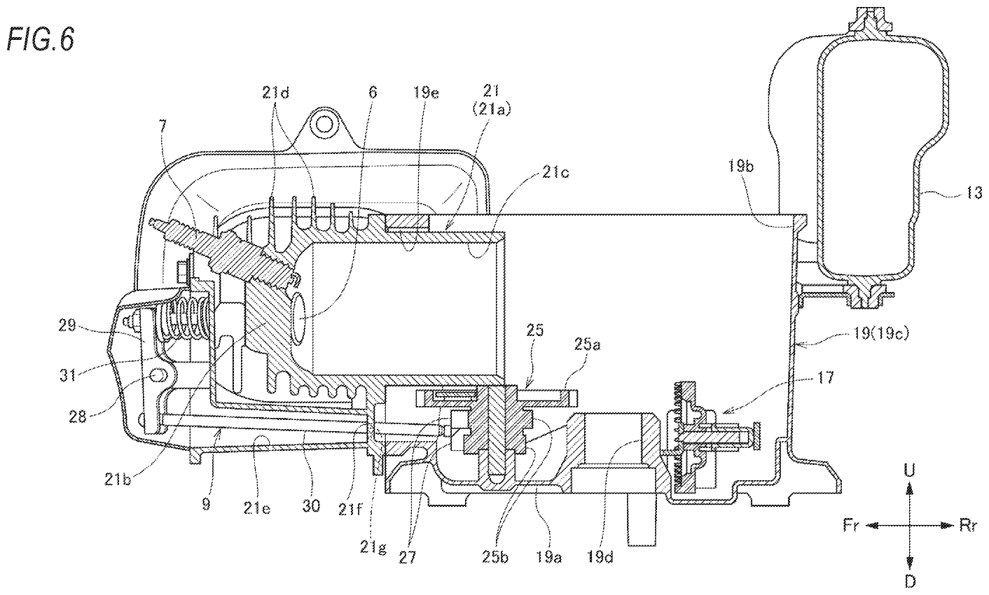

As illustrated in FIGS. 1 to 3, the engine E of the embodiment includes an engine body 1 including a crankcase portion 1a and the cylinder portion 1b, the crankshaft 2 which is rotatably supported by the crankcase portion 1a in the up-down direction, a piston 4 slidably fitted in the cylinder portion 1b and connected to the crankshaft 2 via a connecting rod 3, an intake valve 5, an exhaust valve 6, and a spark plug 7 provided in a head portion 1c of the cylinder portion 1b, ahead cover 8 for covering the head portion 1c of the cylinder portion 1b, a valve mechanism 9 which operates the intake valve 5 and the exhaust valve 6 according to the rotation of the crankshaft 2, a flywheel 10 connected to an upper end of the crankshaft 2, a recoil starter 11 which is placed above the flywheel 10 and starts the engine E, a top cover 12 which covers the top of engine E, a fuel tank 13 for storing fuel, an air cleaner 14 which purifies the air, a carburetor 15 which produces and supplies a mixture of fuel and air to the cylinder portion 1b, a muffler 16 which exhausts the exhaust gas from the cylinder portion 1b while muffling the gas, a governor mechanism 17 (see FIGS. 5 and 6) which automatically opens and closes a throttle valve (not illustrated) of the carburetor 15 according to the rotation speed of the crankshaft 2, and an auto choke mechanism 18 which automatically opens and closes the throttle valve of the carburetor 15 according to the temperature of the engine body 1.

Engine Body

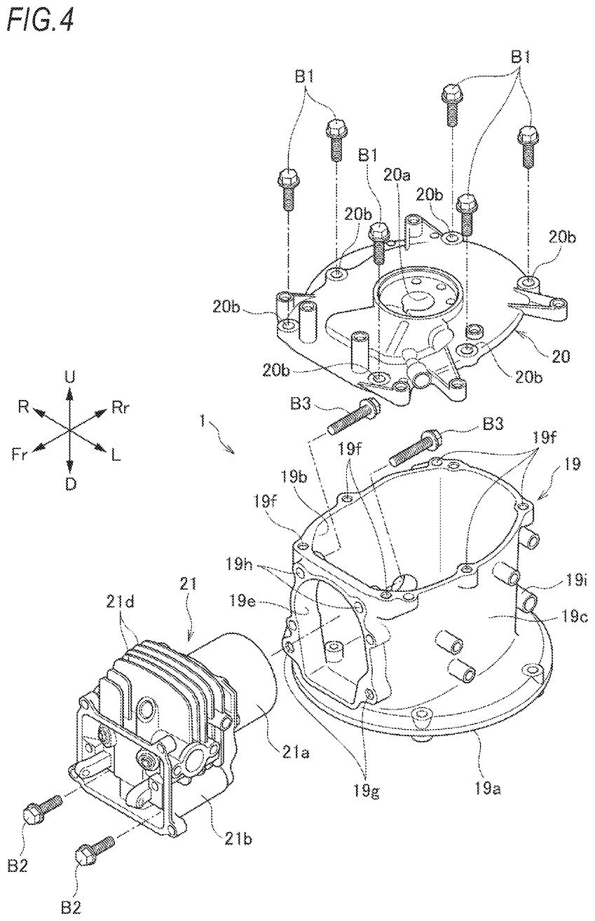

As illustrated in FIG. 4, the engine body 1 includes a crankcase body 19, a crankcase cover 20, and a cylinder unit 21.

As illustrated in FIGS. 4 to 6, the crankcase body 19 includes a bottom portion 19a, and a tubular portion 19c including the bottom portion 19a integrally formed at a lower end portion and a case opening portion 19b at an upper end portion. A first crankshaft insertion hole 19d into which a lower end side of the crankshaft 2 is inserted is formed in the center of the bottom portion 19a and a cylinder insertion hole 19e into which a cylinder base portion 21a of the cylinder unit 21 is inserted is formed in the front surface of the tubular portion 19c. In FIG. 4, reference numerals and letter 19i indicate a drain opening for discharging the oil accumulated inside the crankcase portion 1a.

As illustrated in FIG. 4, the crankcase cover 20 covers the case opening portion 19b of the crankcase main body 19 and forms the crankcase portion 1a of the engine body 1 together with the crankcase main body 19. A second crankshaft insertion hole 20a into which the upper end of the crankshaft 2 is inserted is formed in the center of the crankcase cover 20. Returning to FIG. 1, the crankshaft 2 is rotatably supported between a second bearing 22 provided adjacent to the second crankshaft insertion hole 20a of the crankcase cover 20 and a first bearing 23 provided adjacent to the first crankshaft insertion hole 19d of the crankcase body 19.

The crankcase cover 20 is detachably attached to the upper end of the crankcase body 19 via a plurality of bolts B1. Specifically, a plurality of bolt insertion holes 20b, through which the bolts B1 are inserted from above, are formed in the peripheral portion of the crankcase cover 20 and a plurality of bolt fastening holes 19f into which the bolts B1 are fastened from above are formed in the upper end of the crankcase body 19. The crankcase cover 20 is attached to the crankcase body 19 by fastening the bolts B1 to the bolt fastening holes 19f through the bolt insertion holes 20b. Conversely, the crankcase cover 20 can be removed from the crankcase body 19 by releasing the fastening of the bolts B1 from the bolt fastening holes 19f.

According to the crankcase body 19 and the crankcase cover 20 as described above, by removing the crankcase cover 20 at the time of maintenance of the engine E, the inside of the crankcase body 19 can be accessed from above. In particular, when replacing the crankshaft 2, it is possible to easily replace the crankshaft 2 by removing the crankcase cover 20 and pulling out the crankshaft 2.

As illustrated in FIGS. 4 to 6, the cylinder unit 21 includes the cylinder base portion 21a which is inserted into the cylinder insertion hole 19e of the crankcase body 19 from the front and is located inside the crankcase body 19 and a cylinder block 21b which extends forward from the cylinder base portion 21a and is located outside the crankcase body 19. The cylinder unit 21 alone forms the cylinder portion 1b of the engine body 1 and the front end of the cylinder block 21b forms the head portion 1c. The cylinder base portion 21a and an inner peripheral surface of a cylindrical portion of the cylinder block 21b form a cylinder bore 21c which is a sliding surface with the piston 4 and a large number of cooling fins 21d are provided on the outer peripheral portion of the cylinder block 21b.

According to such cylinder unit 21, by preparing a plurality of types of cylinder unit 21 having different bore diameters, it becomes possible to provide an engine body 1 having different displacements simply by replacing the cylinder unit 21 while making the crankcase body 19 and the crankcase cover 20 common.

The cylinder unit 21 is detachably attached to the crankcase body 19 via a plurality of bolts B2 and B3. For example, when a plurality of bolt insertion holes (not illustrated) through which the bolts B2 are inserted from the front are formed at the rear end of the cylinder block 21b and a plurality of bolt fastening holes 19g for fastening the bolts B2 from the front are formed at the front end of the crankcase body 19, by fastening the bolts B2 to the bolt fastening holes 19g through the bolt insertion holes of the cylinder block 21b, the cylinder unit 21 can be attached to the crankcase body 19. Conversely, by releasing the fastening of the bolts B2 to the bolt fastening holes 19g, the cylinder unit 21 can be removed from the crankcase body 19.

However, in the engine body 1 of the embodiment, when the cylinder unit 21 is detachably attached to the crankcase body 19 via the plurality of bolts B2 and B3, the bolts B3 on the upper end side are fastened to the cylinder unit 21 from the inside of the crankcase body 19. Specifically, a plurality of bolt insertion holes 19h through which the bolts B3 are inserted from the inside of the crankcase body 19 toward the front are formed in the front end of the crankcase body 19 and a plurality of bolt fastening holes (not illustrated) for fastening the bolts B3 from the rear are formed at the rear end of the cylinder block 21b, and further the bolts B3 are fastened to the bolt fastening holes of the cylinder block 21b through the bolt insertion holes 19h of the crankcase body 19.

According to such amounting structure of the cylinder unit 21, since it is not necessary to form a space for fastening the bolts B3 from the front side at least on the upper end side of the cylinder block 21b, the cylinder unit 21 can be attached to the crankcase body 19 without disturbing the external structure (for example, the cooling fin 21d) of the cylinder block 21b, and thus the cooling performance of the engine E can be improved.

Valve Mechanism

As illustrated in FIGS. 6 to 8, the valve mechanism 9 includes a timing gear 24 fixed to the crankshaft 2, a camshaft 25 rotatably supported on the bottom portion 19a of the crankcase body 19, a pair of lifters 27 supported to be swingable on the bottom portion 19a of the crankcase body 19 via stepped bolts 26, a pair of rocker arms 29 which are supported to be swingable at the front end of the cylinder block 21b via rocker arm shafts 28 and one ends of which abut respective the front ends of the intake valve 5 and the exhaust valve 6, a pair of push rods 30 which are accommodated in a push rod accommodation portion 21e formed in the lower part of the cylinder unit 21 and which respectively connect the lifters 27 to the other end portions of the pair of rocker arms 29, and a pair of valve springs 31 for urging the intake valve 5 and the exhaust valve 6 in a closing direction.

A camshaft 25 includes a gear portion 25a which meshes with the timing gear 24 and is rotationally driven by the timing gear 24 at a speed reduction ratio of ½ and a cam portion 25b which alternately pushes the pair of lifters 27 according to the rotational drive of the gear portion 25a. When the cam portion 25b pushes the lifter 27, the other end of the corresponding rocker arm 29 is pushed through the push rod 30 and the intake valve 5 or the exhaust valve 6 connected to one end of the rocker arm 29 is opened. Conversely, when the pushing of the lifter 27 by the cam portion 25b is released, the intake valve 5 or the exhaust valve 6 is closed by the urging force of the valve spring 31.

The camshaft 25 of the embodiment is arranged below the cylinder base portion 21a of the cylinder unit 21. When the camshaft 25 is arranged as such, it is possible to access the inside of the crankcase body 19 from the top without removing the camshaft 25 by simply removing the crankcase cover 20 when maintaining the engine E.

In FIG. 6, reference numerals and letter 21g indicates a communication hole provided in a rear wall 21f of the push rod accommodation portion 21e. The communication hole 21g is provided at the lowest position when the oil accumulated inside the crankcase portion 1a is discharged from the drain opening 19i of the crankcase body 19 to the outside. The communication hole 21g guides the oil accumulated in the head portion 1e and the push rod accommodation portion 21e to the crankcase portion 1a. Therefore, it is possible to more reliably prevent the accumulation of oil in the push rod accommodation portion 21e when the oil is discharged.

The embodiment described above can be appropriately modified, improved, and the like. For example, in the embodiment described above, the up-down direction is described as the first direction, but the first direction may be a left-right direction or a front-back direction.

In the embodiment described above, the crankcase cover 20 is attachable to and detachable from the crankcase body 19, but the crankcase cover 20 may be formed integrally with the crankcase body 19.

At least the following matters are described in the specification. Although the constituent elements and the like corresponding to those of the embodiment described above are shown in parentheses, the invention is not limited thereto.

(1) An engine which includes:

a crankcase portion (crankcase portion 1a) including a first crankshaft insertion hole (first crankshaft insertion hole 19d) and a second crankshaft insertion hole (second crankshaft insertion hole 20a) along a first direction (up-down direction);

a crankshaft (crankshaft 2) inserted through the first crankshaft insertion hole and the second crankshaft insertion hole; and

a cylinder unit (cylinder unit 21) extending from the crankcase portion in a second direction (front-back direction) orthogonal to the first direction, where

the cylinder unit includes,

a cylinder base portion (cylinder base portion 21a) located inside the crankcase portion, and

a cylinder block (cylinder block 21b) located outside the crankcase portion, and

the cylinder unit is detachably attached to the crankcase portion.

According to (1), since the cylinder unit is detachably attached to the crankcase portion, it is possible to provide an engine body with different displacements simply by replacing the cylinder unit.

(2) The engine according to (1), where

the crankcase portion includes a crankcase body (crankcase body 19) and a crankcase cover (crankcase cover 20) detachably attached to the crankcase body,

the cylinder unit is fastened to the crankcase body with a plurality of bolts (bolts B2, B3), and

at least one (bolt B3) of the plurality of bolts is fastened from the inside of the crankcase portion.

According to (2), the cylinder unit can be attached to the crankcase without interfering with the external structure (for example, the cooling fin) of the cylinder block.

(3) The engine according to (1) or (2), where

the engine includes a valve mechanism (valve mechanism 9),

the valve mechanism includes,

a timing gear (timing gear 24) fixed to the crankshaft,

a camshaft (camshaft 25) rotatably supported by the crankcase portion,

a pair of lifters (lifters 27) supported to be swingable on the crankcase portion,

a pair of rocker arms (rocker arms 29) which are supported to be swingable via rocker arm shafts (rocker arm shafts 28) and one ends of which abut against respective an intake valve (intake valve 5) and an exhaust valve (exhaust valve 6),

a pair of push rods (push rod 30) connecting the pair of lifters to another ends of the pair of rocker arms, and

a pair of valve springs (valve springs 31) urging the intake valve and the exhaust valve in a closing direction, and

the pair of push rods are accommodated in a push rod accommodation portion (push rod accommodation portion 21e) provided in the cylinder block.

According to (3), since the push rod accommodation portion is integrally formed in the lower portion of the cylinder block, the number of parts can be reduced, and thus the manufacturing cost can be reduced.

(4) The engine according to (3), where

the push rod accommodation portion is provided with a communication hole (communication hole 21g) which communicates with the inside of the crankcase portion.

According to (4), since the oil accumulated in the push rod accommodation portion flows into the crankcase portion through the communication hole, the oil can be prevented from accumulating in the push rod accommodation portion.

(5) The engine according to (4), where

the communication hole is provided at a lowest position when oil accumulated inside the crankcase portion is discharged to the outside from a drain opening (drain opening 19i) of the crankcase portion.

According to (5), since the communication hole is provided at the lowest position when the oil accumulated inside the crankcase portion is discharged to the outside from the drain opening of the crankcase body, it is possible to more reliably prevent the oil from accumulating in the push rod accommodation portion during oil discharge.

(6) An engine (engine E) which includes:

a crankcase body (crankcase body 19) including a bottom portion (bottom portion 19a) provided with a first crankshaft insertion hole (first crankshaft insertion hole 19d), and a tubular portion (tubular portion 19c) provided with the bottom portion in one-piece construction at one end in a first direction and a case opening portion (case opening portion 19b) at another end in the first direction:

a crankcase cover (crankcase cover 20) provided with a second crankshaft insertion hole (second crankshaft insertion hole 20a) and covering the case opening portion of the crankcase body; and

a cylinder unit (cylinder unit 21) extending from the tubular portion in a second direction orthogonal to the first direction, wherein

the tubular portion is provided with a cylinder insertion hole (cylinder insertion hole 19e) which opens in the second direction,

the cylinder unit includes,
a cylinder base portion (cylinder base portion 21a) located inside the crankcase body, and
a cylinder block (cylinder block 21b) located outside the crankcase body,

the crankcase cover is detachably attached to the crankcase body, and

the cylinder unit is detachably attached to the crankcase body.

According to (6), since the engine is divided into the crankcase body, the crankcase cover, and the cylinder unit, it is possible to provide an engine with different displacements simply by replacing the cylinder unit.

Further, since the crankcase cover is detachably attached to the crankcase body, the inside of the crankcase body 19 can be accessed by removing the crankcase cover 20 at the time of maintenance of the engine.

(7) The engine according to (6), where

the cylinder unit is fastened to the crankcase body by bolts (bolts B2 and B3), and

a bolt (bolt B3) of the bolts on the another end in the first direction is fastened from the inside of the crankcase body.

According to (7), the cylinder unit can be attached to the crankcase body without disturbing the external structure (for example, the cooling fin) of the cylinder block.

What is claimed is:

1. An engine comprising:
a crankcase portion including a first crankshaft insertion hole and a second crankshaft insertion hole along a first direction;
a crankshaft inserted through the first crankshaft insertion hole and the second crankshaft insertion hole; and
a cylinder unit extending from the crankcase portion in a second direction orthogonal to the first direction, wherein
the cylinder unit includes,
a cylinder base portion located inside the crankcase portion, and
a cylinder block located outside the crankcase portion, and
the cylinder unit is detachably attached to the crankcase portion.

2. The engine according to claim 1, wherein
the crankcase portion includes a crankcase body and a crankcase cover detachably attached to the crankcase body,
the cylinder unit is fastened to the crankcase body with a plurality of bolts, and
at least one of the plurality of bolts is fastened from the inside of the crankcase portion.

3. The engine according to claim 1, wherein
the engine includes a valve mechanism,
the valve mechanism includes,
a timing gear fixed to the crankshaft,
a camshaft rotatably supported by the crankcase portion,
a pair of lifters supported to be swingable on the crankcase portion,
a pair of rocker arms which are supported to be swingable via rocker arm shafts and one ends of which abut against respective an intake valve and an exhaust valve,
a pair of push rods connecting the pair of lifters to another ends of the pair of rocker arms, and
a pair of valve springs urging the intake valve and the exhaust valve in a closing direction, and
the pair of push rods are accommodated in a push rod accommodation portion provided in the cylinder block.

4. The engine according to claim 3, wherein
the push rod accommodation portion is provided with a communication hole which communicates with the inside of the crankcase portion.

5. The engine according to claim 4, wherein
the communication hole is provided at a lowest position when oil accumulated inside the crankcase portion is discharged to the outside from a drain opening of the crankcase portion.
